(19) United States
(12) Patent Application Publication
(10) Pub. No.: US 2006/0097658 A1
(43) Pub. Date: May 11, 2006

(54) Apparatus for adjusting brightness of indicator light on panel

(76) Inventors: Vicent Chiang, Taipei (TW); Hui-Huang Lin, Taipei (TW); Kun-Chih Lu, Taipei (TW); Stan Cheng, Taipei (TW); Bo-Tai Chen, Taipei (TW); Shih-Jie Lee, Taipei (TW)

Correspondence Address: Yi-Wen Tseng, 4331 Stevens Battle Lane, Fairfax, VA, 22033, US

(21) Appl. No.: 10/975,548

(22) Filed: Oct. 29, 2004

(51) Int. Cl. H05B 41/36

(52) U.S. Cl. 315/291

(57) ABSTRACT

An apparatus for adjusting brightness of indicator light on a panel is provided. By employing pulse width modulated signals, one can control the amount of current flowing into the indicator light, thereby adjusting the brightness of the indicator light. The apparatus includes a control unit, which generates pulse width modulated signals in response to a user defined condition, and a switch element, which is coupled between the output end of the indicator light and the resistor for receiving the pulse width modulated signals, thereby controlling the amount of current flowing into the input end of the indicator light. One can thus obtain optimized indicating effects and visual comforts.

### BACKGROUND OF THE INVENTION

The present invention relates generally to an apparatus for adjusting brightness of indicator light on a panel, and more particularly to an apparatus that can digitally adjust brightness of indicator light on a panel by accessing a software window.

The working status of an electronic product is generally displayed on a display unit connected therewith. The most convenient way to display the working status is by using an indicator light. The user of the electronic product can easily realize the working status of the electronic product, such as a power supply, a computer storage device, or a data access device (e.g. DVD, VCD players, etc.). The indicator light is normally a light emitting diode (LED), as shown in FIG. 1, which is electrically connected to a power supply through a resistor, so as to obtain a fixed brightness for the LED. Such an electrical connection provides the LED with fully current when supply the LED with electrical power. The user can not change the brightness of the LED. Furthermore, since the advancement of the LED technology has produced LEDs with higher and higher brightness, they often become too bright to achieve the purpose of an indicator light.

### BRIEF SUMMARY OF THE INVENTION

Therefore, the present invention is to provide an apparatus for adjusting brightness of an indicator light on a panel, such that the problems of the conventional indicator light that has fixed and unchangeable brightness can be solved. The apparatus of the present invention employs a pulse width modulator to adjust the current flowing into the indicator light. The user can easily adjust the brightness of the indicator light through a software window at any time.

Accordingly, the apparatus for adjusting brightness of indicator light on a panel includes a control unit, which generates pulse width modulated signals in response to a user defined condition, and a switch element, which is coupled between the output end of the indicator light and the resistor for receiving the pulse width modulated signals, thereby controlling the amount of current flowing into the input end of the indicator light.

### BRIEF DESCRIPTION OF THE DRAWINGS

These as well as other features of the present invention will become more apparent upon reference to the drawings therein:

FIG. 1 illustrates a conventional apparatus for adjusting brightness of an indicator light.

FIG. 2 illustrates an apparatus for adjusting brightness of an indicator light assembly in accordance with one embodiment of the present invention.

FIG. 3 is a diagram illustrating control pulses that set the brightness of the indicator light to zero.

FIG. 4 is a diagram illustrating control pulses that set the brightness of the indicator light to half level.

FIG. 5 is a diagram illustrating control pulses that set the brightness of the indicator light to full level.

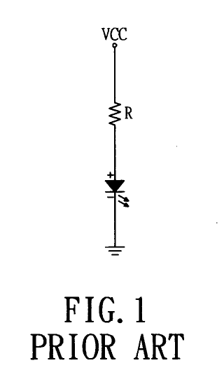

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

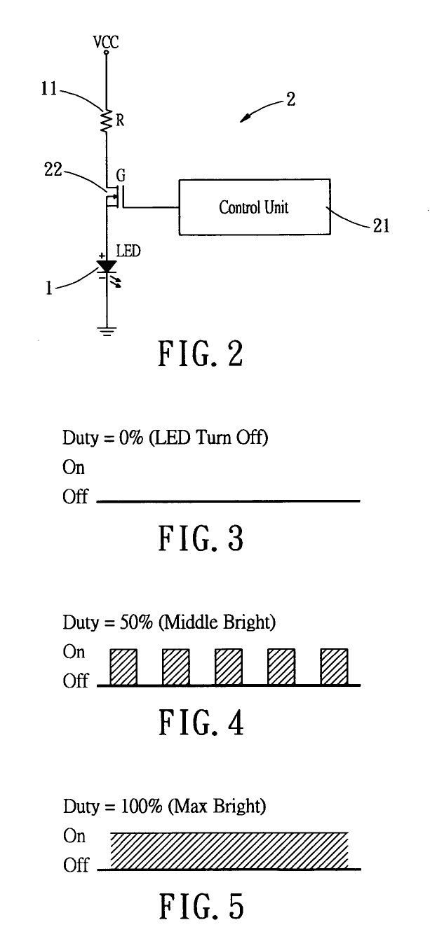

Referring to FIG. 2, the apparatus for adjusting brightness of indicator light on a panel is illustrated. The apparatus includes at least an indicator light 1 and a light adjusting device 2 for adjusting the brightness of the indicator light 1. Although only one indicator light is illustrated in FIG. 2, it is appreciated that the present invention is also applicable to apparatus having many indicator lights.

In this particular embodiment, the indicator light 1 is a light emitting diode (LED). The input end of the indicator light 1 is electrically coupled to one end of a resistor 11. The other end of the resistor 11 is coupled to a power supply.

The light adjusting device 2 is electrically coupled between the input end of the indicator light 1 and the resistor 11 for adjusting the current flown into the indicator light 1, thereby adjusting the brightness of the indicator light 1. The light adjusting device 2 includes a control unit 21 and a switch element 22, as shown in FIG. 2.

In one embodiment, the control unit 21 of the light adjusting device 2 is a pulse width modulator (PWM). The control unit 21 incorporates with a software program and an operation window for users to select and control the adjustments. According to modulation control instructions, pulse width modulated signals are thus generated and become the driving signals for controlling the current flow via the switch element 22.

In one embodiment, the software program for executing and adjusting the control unit 21 is a resident program. After the program is loaded, an icon will be generated. The users can easily start a control window to adjust the brightness of the indicator light 1 by using the icon.

The switch element 22 is coupled between the input end of the indicator light 1 and the resistor 11. The signal input end of the switch element 22 is coupled to the output end of the control unit 21. By using the pulse width modulated signals output from the control unit 21, one can control the amount of current flown into the indicator light 1. Consequently, the brightness of the indicator light 1 is adjusted and controlled.

In this particular embodiment, the switch element 22 is a semiconductor switch element, as shown in FIG. 2. It is appreciated that the switch element 22 can be any other electronic switch elements.

Referring to FIG. 2 to FIG. 5, the operation of the apparatus for adjusting indicator light on a panel is hereinafter described in detail. The user can simply click on the icon of the software program to start a control window. In the control window, one can find an adjustment field and select brightness of the indicator light from 0% to 100% brightness. When the user sets the brightness of the indicator light 1 to 0%, the software program will drive the control unit 21 to generate pulse width modulated signals that turns the switch element 22 off, as shown in FIG. 3. Since the switch element 22 is off, no current is flown through the indicator light 1. Therefore, the indicator light 1 generates no light.

If the user wants the indicator light 1 to have 50% brightness, the user should then select the 50% option from the adjustment field using the control window. The software program then drives the control unit 21 to output pulse width modulated signals, which correspond to 50% brightness, as shown in FIG. 4. The pulse width modulated signals then controls switch element 22 to allow only one-half of the total current. Thus, the indicator light 1 can produce light of 50% brightness. Furthermore, if the user wants the indicator light 1 to have maximum brightness, the user should then select the 100% option from the adjustment field using the control window. The software program then drives the control unit 21 to output pulse width modulated signals, which correspond to 100% brightness, as shown in FIG. 5. The pulse width modulated signals then controls switch element 22 to allow total amount of current to flow through the indicator light 1. Therefore, the indicator light can produce light of full brightness.

The features and advantages of the apparatus for adjusting brightness of an indicator light 1 of the present invention are the following:
1. The brightness of the indicator light installed on a panel can easily be adjusted by employing the control unit and the switch element incorporating with the software program to obtain an optimized indicating effect and visual comfort.
2. The brightness of the indicator light installed on a panel can easily be adjusted by employing the icon shown on a display to start the control window, thereby adjusting and changing the brightness of the indicator light as needed.
3. The brightness of the indicator light can be adjusted in response to the brightness of the environment.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. An apparatus for controlling brightness, comprising:
an indicator light installed on a panel;
a resistor coupled to an input end of the indicator;
a switch element coupled between an output end of the indicator light and the resistor; and
a control unit for outputting pulse width modulated signals to the switch element so as to control an amount of current flowing through the indicator light, thereby controlling the brightness of the indicator light.

2. The apparatus as recited in claim 1, wherein the control unit is driven according to a user defined condition entered through a control window of a software program.

3. The apparatus as recited in claim 2, wherein the software program establishes an icon when loaded as a resident program for user to easily click and start the control window, thereby controlling the brightness of the indicator light.

4. The apparatus as recited in claim 1, wherein the control unit is a pulse width modulator.

5. The apparatus as recited in claim 1, wherein the switch element is a semiconductor switch element.

6. The apparatus as recited in claim 1, wherein the switch element is an electronic switch element.

7. An apparatus for controlling brightness of an indicator light on a panel, comprising:
an indicator light installed on a panel, with an input end coupled to a resistor;
a light adjusting device coupled between an input end of the indicator light and the resistor for controlling the amount of current inputting into the indicator light, thereby controlling the brightness of the indicator light.

8. The apparatus as recited in claim 7, wherein the light adjusting device comprises:
a control unit, outputting pulse width modulated signals in response to a user defined condition;
a switch element coupled between the output end of the indicator light and the resistor for receiving the pulse width modulated signals, controlling the amount of current flowing into the input end of the indicator light, thereby controlling the brightness of the indicator light.
